(19) United States
(12) Patent Application Publication
(10) Pub. No.: US 2007/0168223 A1
(43) Pub. Date: Jul. 19, 2007

(54) CONFIGURABLE CLINICAL INFORMATION SYSTEM AND METHOD OF USE

(76) Inventors: Steven Lawrence Fors, Chicago, IL (US); Michael Thomas Randazzo, South Jordan, UT (US)

Correspondence Address: MCANDREWS HELD & MALLOY, LTD, 500 WEST MADISON STREET, SUITE 3400, CHICAGO, IL, 60661, US

(21) Appl. No.: 11/463,218

(22) Filed: Aug. 8, 2006

Related U.S. Application Data
(60) Provisional application No. 60/729,944, filed on Oct. 26, 2005.
(60) Provisional application No. 60/725,954, filed on Oct. 12, 2005.
(60) Provisional application No. 60/726,917, filed on Oct. 14, 2005.
(60) Provisional application No. 60/726,537, filed on Oct. 14, 2005.
(60) Provisional application No. 60/726,075, filed on Oct. 12, 2005.
(60) Provisional application No. 60/725,761, filed on Oct. 12, 2005.
(60) Provisional application No. 60/726,536, filed on Oct. 14, 2005.

(51) Int. Cl. G06Q 10/00

(52) U.S. Cl. 705/2

(57) ABSTRACT

Certain embodiments of the present invention provide a user-configurable clinical information system. Certain embodiments provide for a user-configurable data and functionality entry and retrieval system. Certain embodiments provide a system and method for configuration and/or customization of patient and practice data entry, analysis and manipulation. Certain embodiments provide a configurable system that allows easy update of components and rules transparently to a user. In an embodiment, a user may dynamically make changes to the system. Certain embodiments of the present invention provide a configurable system that provides greater flexibility, greater usability, greater diagnosis and support, and greater functionality for healthcare practitioners.

### RELATED APPLICATIONS

This application claims the benefit of U.S. Provisional Application No. 60/729,944, filed Oct. 14, 2005, entitled “Configurable Clinical Information System and Method of Use;” U.S. Provisional Application No. 60/725,954, filed Oct. 12, 2005, entitled “Third Party Application Launcher;” U.S. Provisional Application No. 60/726,917, filed Oct. 14, 2005, entitled “Configurable System and Method for Results Review;” U.S. Provisional Application No. 60/726,537, filed Oct. 14, 2005, entitled “Configurable System and Method for Order Entry;” U.S. Provisional Application No. 60/726,075, filed Oct. 12, 2005, entitled “Method of Protecting Patient Privacy in CIS Application;” U.S. Provisional Application No. 60/725,761, filed Oct. 12, 2005, entitled “User-Selectable Low-Bandwidth Logon Option for Web-Based Clinical Information View Application;” and U.S. Provisional Application No. 60/726,536, filed on Oct. 14, 2005, entitled “System and Method for Clinical Decision Support”. The '944, '954, '917, '537, '075, '761 and '536 applications are hereby incorporated by reference herein in their entirety.

### BACKGROUND OF THE INVENTION

The present invention generally relates to patient management. More specifically, the present invention relates to consolidation and configuration of patient and practice management.

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

The Health Insurance Portability and Accountability Act (HIPAA) provides for a variety of requirements for the protection of the privacy of patients. For a variety of reasons, including patient privacy and HIPAA requirements, there is a need for systems and methods to protect patient privacy in medical applications.

Many hospitals and clinics generate electronic medical data in response to examinations and tests. For example, upon performing a battery of tests on a patient's blood sample, a laboratory may generate electronic data to represent the results of the battery of tests. These results may then be reviewed by a physician, radiologist, nurse or other user. These results may be stored in an information system, such as a system described above.

Additionally, orders are written by physicians, radiologists, and/or other healthcare practitioners to generate tests, diagnosis, and/or treatment information, for example. However, the current systems and methods for order entry do not permit users to dynamically alter the manner in which order entry options and information are presented to the user. Current systems and methods use hard-coded, fixed forms for the entry of data. These systems and methods do not provide for any configuration capability and do not allow a user to customize an order entry form presenting order options dynamically.

Furthermore, current systems and methods for reviewing medical results do not permit users to dynamically alter the manner in which the results are presented to the user. Current systems and methods use hard-coded, fixed reports for the presentation of results. These systems and methods do not provide for any configuration capability and do not allow a user to customize a report presenting results dynamically.

Clinical decision support systems provide assistance to healthcare providers such as physicians. For example, clinical decision support systems can aid a physician in making decisions regarding diagnosis and/or treatment. As another example, clinical decision support systems may perform interaction checking on prescription orders for possible adverse drug interactions. A clinical decision support system may be part of a clinical information system (CIS) and/or hospital information system (HIS), for example. A clinical decision support system may utilize information stored in and/or received from other systems such as RIS, CVIS, PACS, LIS, and EMR.

Current clinical decision support systems are predefined, inflexible, and not configurable. That is, current systems do not allow users such as physicians to define rules and configure existing rules. That is, current systems require administrative and/or engineering resources and/or personnel to build rules and deploy a clinical decision support system. In addition, current decision support systems use complex and confusing syntax to write code using Booleans and database schema to cover situations, precluding non-technical users from developing rules. Thus, there is a need for a flexible clinical decision support. Further, there is a need for an easy to use interface for specifying and modifying rules for a clinical decision support system.

Current information and management systems do not offer interconnection and flexibility. Current clinical information systems are typically modified manually by programmers for particular users. Many components of a patient care or practice management workflow are paper-based or not present at all. Current systems do not provide a central system by which a user may access and interrelate patient information, resource information, orders, and results.

Thus, a need exists for systems and methods that permit users to dynamically alter patient and practice management functionality and data. Additionally, a need exists for systems and methods with configuration capability allowing a user to interactively relate patient and practice management functionality and data. Such systems and methods may provide for comprehensive patient and/or practice management on a single computer screen or other portal. In addition, such systems and methods may provide for the customization of the manner in which information is entered by a user. Furthermore, systems and methods facilitating interactions with third party applications and protecting patient privacy would be highly desirable. Systems and methods accommodating varying available bandwidth would also be highly desirable.

### BRIEF SUMMARY OF THE INVENTION

Certain embodiments of the present invention provide for a user-configurable clinical information system. Certain embodiments provide a system and method for configuration and/or customization of patient data entry and analysis. Certain embodiments provide a configurable system that allows easy update of components and rules transparently to a user. In an embodiment, a user may dynamically make changes to the system. Certain embodiments of the present invention provide a configurable system that provides greater flexibility, greater usability, greater diagnosis and support, and greater functionality for healthcare practitioners.

Certain embodiments provide a method for providing functionality and data for patient and practice management via a user interface. The method includes interrelating a plurality of functionality related to at least one of patient care and clinical management. The method also includes facilitating access to the interrelated plurality of functionality via a coordinated user interface. The method further includes delivering at least a portion of the interrelated plurality of functionality to a user.

Certain embodiments provide a user interface system for clinical applications and data. The system includes a memory storing a plurality of functionality and data related to at least one of patient management and practice management. The system also includes a user interface configured as a portal to the plurality of functionality. The user interface provides coordinated access to the functionality and data and is customizable by a user.

Certain embodiments provide a computer readable medium including a set of instructions for execution on a computer. The set of instructions includes a plurality of clinical functionality facilitating patient care and practice management. Additionally, the set of instructions includes data related to the clinical functionality. The set of instructions also includes a user interface routine facilitating access to the plurality of clinical functionality and data through a centralized access point. The set of instructions further includes a rules routine interrelating the plurality of clinical functionality.

### BRIEF DESCRIPTION OF SEVERAL VIEWS OF THE DRAWINGS

FIG. 1 illustrates an example of a practice management system used in accordance with an embodiment of the present invention.

FIGS. 2a-2b illustrate screenshots of patient record applications used in accordance with an embodiment of the present invention.

FIG. 3 illustrates a system for clinical decision support used in accordance with an embodiment of the present invention.

FIG. 4 illustrates an interface for rule management used in accordance with an embodiment of the present invention.

FIG. 5 illustrates a flow diagram for a method for clinical decision support used in accordance with an embodiment of the present invention.

FIG. 6 illustrates a system for patient and practice management in accordance with an embodiment of the present invention.

FIG. 7 illustrates a flow diagram for a method for providing access to clinical functionality and data in accordance with an embodiment of the present invention.

FIGS. 8a-8d illustrate exemplary third party application features used in accordance with embodiments of the present invention.

FIGS. 9a-9b illustrate exemplary aliasing applications used in accordance with embodiments of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

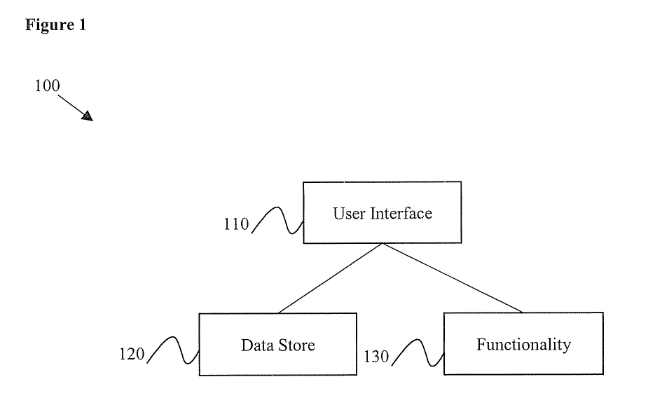

Certain embodiments of the present invention provide for systems and methods for medical practice management. FIG. 1 illustrates an example of a practice management system 100 including a user interface 110, a data store 120, and functionality 130 used in accordance with an embodiment of the present invention. Functionality 130 may include one or more subsystems and/or applications including an order entry system, a results review system, a patient information system, a clinical decision support system, a configuration management system, a medication management system, a clinical information viewer, an allergy/problems database, a printing/reporting module, security, patient privacy protection, clinical scheduling, personal calendar, electronic mail, electronic messaging or “chat”, and/or medical resources, for example. Functionality 130 may be implemented in hardware, software and/or firmware, for example. Data store 120 may include one or more memories, storage drives, data structures, caches, and/or other data storage media, for example.

The interface 110 allows access to the data store 120 and/or functionality 130. The interface 110 also facilitates interaction between different functionality 130 and between functionality 130 and data in the data store 120. In certain embodiments, the system 100 provides an integrated system for access to functionality 130 and data. The interface 110 serves as a central interface to access information and applications, for example. Data in the data store 120 may be viewed in a plurality of ways via different functionality 130 through the interface 110. Additionally, data may be manipulated and propagated from one application to another application using the functionality 130. Data may be generated, modified, stored and/or used in one application and then communicated to another application to be modified, stored and/or used, for example.

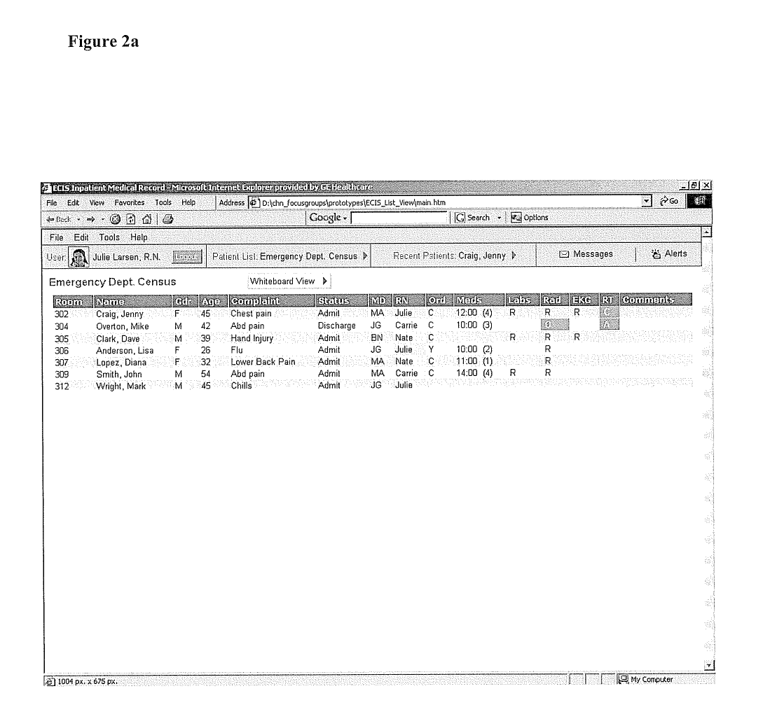

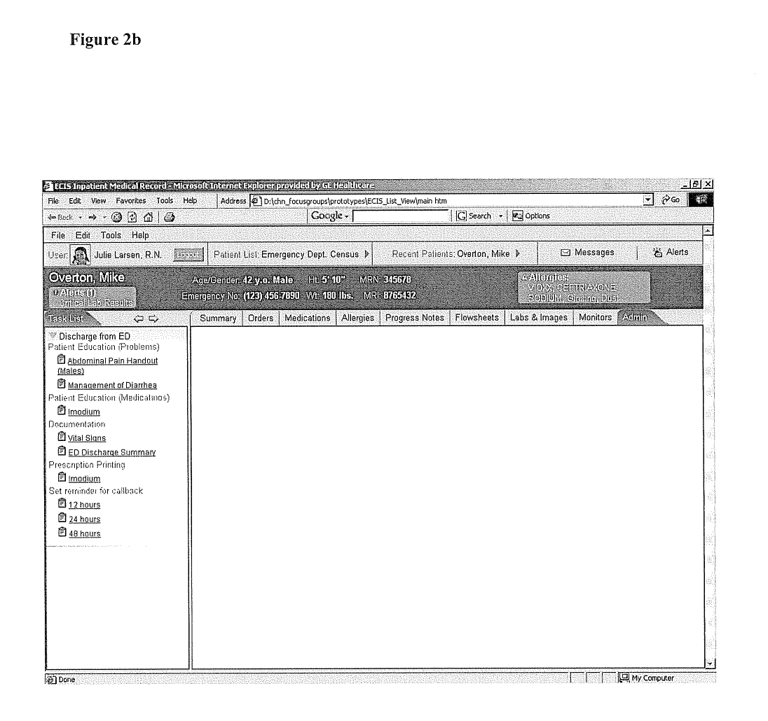

For example, as shown in FIGS. 2a and 2b, a user may “click on” or otherwise select an entry in a patient list, and enter orders, request additional information, manage prescriptions, review results, etc., with respect to the selected patient. Patient information and/or other default and/or rules-based information may propagate from the patient record to help complete an order entry form, electronic prescription, results review, etc., for the patient, for example. For example, information from examination notes and laboratory results may propagate to an order entry form which may then propagate to a medication management application.

The interface 110 is configured to provide a centralized portal for access to patient and other medical data as well as patient, clinical and practice management applications and other functionality, for example. The interface 110 provides easy access to information and services. The interface 110 allows a user to manage patient care and/or office management workflow, for example. The interface 110 may be accessible locally (e.g., in the office) and/or remotely (e.g., via the Internet and/or other private network or connection).

The interface 110 may be configured to help or guide a user in accessing data and/or functions to facilitate patient care and practice management, for example. The interface 110 provides connectivity between functionality 130 and/or data. The interface 110 facilitates easy data flow between functionality 130 and data and enables links between functionality 130 and data.

In certain embodiments, the interface 110 may be configured according to certain rules, preferences and/or functions, for example. A user may customize the interface 110 according to particular desires, preferences and/or requirements. In certain embodiments, a default interface 110 may be provided to a user. In certain embodiments, the default interface 110 is capable of being adjusted and/or otherwise modified by the user. In certain embodiments, a user may define an interface 110 for interaction with functionality 130 and data. In certain embodiments, an interface configuration may change dynamically in response to available data, functionality and/or operating conditions, for example.

In certain embodiments, a default interface 110 may be provided to a user. In certain embodiments, a user may select among a plurality of interfaces 110 depending upon application, situation, preference, and/or other criterion, for example. In certain embodiments, a user may modify an existing interface 110 and/or create a new interface 110. In certain embodiments, the user may save a modified and/or created interface 110 for later use.

FIG. 2a illustrates an exemplary patient medical record listing application used in accordance with an embodiment of the present invention. The application may be made available to a user via the interface 110 for example. A patient list application, such as the application shown in FIG. 2a, may list patients currently present in a healthcare facility or department and/or a total listing of patients cared for by the healthcare facility or department, for example. The application may provide identification information, location information, complaint information, status information, treatment information, history information, and/or other comment, for example. A user may be able to alter information for a patient via the application interface show in FIG. 2a. Alternatively and/or in addition, examination, treatment and/or other action in other functionality 130 and/or data may automatically alter the contents of the patient list.

FIG. 2b illustrates an example of a patient record used in accordance with an embodiment of the present invention. The patient record provides identification information, allergy and/or ailment information, history information, orders, medications, progress notes, flowsheets, labs, images, monitors, summary, administrative information, and/or other information, for example. The patient record may include a list of tasks for a healthcare practitioner and/or the patient, for example. The patient record may also identify a care provider and/or a location of the patient, for example.

Some exemplary subsystems, data, and/or functions of certain embodiments of the present invention will be described below in more detail.

1. Order Entry System

Certain embodiments of the present invention provide for configurable order entry form(s). An order form may mimic a paper form, which may encourage doctors or other users to use the computer to complete an order form, for example. An order entry form may be configurable based on one or more default values, rules, user preferences, treatment or diagnosis-specific rules, etc.

In an embodiment, a form designer allows for the development of components. A site administrator and/or a user may create and/or manipulate those components to configure a form for use by, for example, users such as doctors and/or nurses. Components may include one or more of, for example, information, options, and fields. In an embodiment, a form configuration tool may be used to select and place components on the screen to generate a form. In certain embodiments, a base form may be created. In an embodiment, forms may inherit from a base form. Features and/or components may be added to an existing form to create another form. The forms may exist in a hierarchy, for example. In an embodiment, a user may customize, patch, or alter a form. A form may include, for example, an urgency (e.g., stat, etc.). In an embodiment, a user may arrange categories, subcategories, etc., in a form on-site.

In certain embodiments, the order form configuration tool may be used to set, for example, required fields, default values, default forms, and/or default orders. In an embodiment, a user may customize defaults. In an embodiment, a user may restrict fields to certain values. In addition, a user may require a field not to have certain values. The order form configuration tool may store a history of how a form was modified. In one implementation, if a form or field is changed and/or updated, historically recorded forms remain unchanged. For example, if a field is added to a form 2 weeks after Physician A has filled out such a form, Physician A's form remains unchanged. That is, the new field is not added to a historical, saved form.

Once a form has been configured, a user, such as doctors or nurses, may then select the form, complete the form, and/or save it. The order form system may not allow a form to be saved with required fields left unfilled. In an embodiment, the tool may provide indicators to tell whether a field is required or not. In an embodiment, the tool may provide indicators to tell whether a field is filled or unfilled. In one implementation, a user may drop consents and/or help information on the form.

In certain embodiments, icons may be placed on an order form menu in association with different forms to tell the user at a glance some characteristics of the form. For example, an icon may represent that no co-sign is needed for the form.

The order form configuration system is easy to update and allows easy addition and removal of code and components to the framework. The system is also more flexible for the user. Components in the form may be individual Java classes, for example. Placing a component on a form may instantiate a new class. An architecture of “listeners” may be set up between the components to help the components operate autonomously and interact with other components. For example, this allows components to interact even when it is not known ahead of time which components will be on a form.

In certain embodiments, rules may be established relating components, providing guidelines and/or restrictions. The order form design framework may be used to implement standards for, for example, dosage and required fields. These standards may be for compliance with rules, standards, and/or guidelines of, for example, the American Medical Association (AMA), Food and Drug Administration (FDA), and/or Joint Council on Accreditation of Healthcare Organizations (JCAHO). In an embodiment, the order form may be configured to convert and/or clarify values entered by a user to avoid confusion or satisfy compliance. For example, the order form framework may automatically update software to ensure compliance and/or ensure forms have the current rules and/or tools. Thus, a user may not have to wait for a whole new version to be compliant with new FDA rules, as an example.

In an embodiment, a user may fill out an order and specify “save as common”. That is, the order form tool may write the completed order to user's personal list of common orders. A user may select from the list of common orders to use the order on another patient with a single click. Additionally, the system may “lean” a user's defaults. Default values may be specified based on, for example, a user profile. That is, values may be tied to one or more fields for a particular user or type of user.

In an embodiment, the order form system may also facilitate the indication concept. That is, a form may ask a user why he/she is ordering a certain medication. The user can fill in an answer. The system may link diagnosis to treatment. For example, the system may suggest forms, medications, other treatments based on malady/diagnosis, and/or show history/examples of other treatments. The system may store predefined care plans based on problem. Plans may then be optimized based on, for example, cost.

Certain embodiments of the present invention provide for a configurable order panel. The configurable order panel may, for example, hover over items and provide related information about the orders. In an embodiment, hovering over an item may also launch a web page, such as, for example, an x-ray image displayed in a browser.

Certain embodiments of the present invention provide for an ordering screen that allows the user to define custom ordering schedules. For example, a user could say every M/W/F at 9 and 12 or some recurring schedule. In an embodiment, a user may configure an order which represents one large order spread out into many smaller orders. For example, tapering/weaning of medication or reducing dosage over time.

In an embodiment, interaction checking may include dose range checking. In an embodiment, the system may display data and user response. The user may then, for example, ignore certain ones, modify an order, and/or remove the order. In an embodiment, the user may capture the data and send it to a pharmacist.

In an embodiment, the system provides an order review screen. The order review screen may allow a user to review orders on a patient. The user may be able to configure or define how to review an order. In an embodiment, filters may be used to review an order. For example, filters may include custom filters such as show only medications, only certain medication, only anesthesia medications for patient A, or only chest x-rays. As another example, filters may filter based at least in part on clinical relevance based on the patient.

Certain embodiments provide for order sets. An order set may include a collection of orders around a certain problem, for example. A diabetic order set, for example, may include standard care for a diabetic. Examples of order sets may include pre-heart surgery order sets and post-surgery order sets. Order sets may be configured by, for example, sites and/or users. Order sets allow a single entry to start a patient on a care plan. In an embodiment, order sets may be configured, grouped, displayed, and/or re-ordered. An order set may be re-ordered if, for example, a patient comes back with the same problem. In certain embodiments, users may view order text, track where orders come from, and group by order sets (e.g., these came from admission, these from pre-op, etc.). In an embodiment, a user may look across patients and see what physicians ordered from what order sets. A user may determine if everything from an order set was used, which order sets were used, track conformance, track trends/effectiveness, for example. In an embodiment, a generic order set is provided. A generic order set may provide a collection of antibiotics and a user is forced to pick one from the list.

In certain embodiments, information for a patient in a patient list may be transferred manually and/or automatically to populate an order entry form or configure an order entry form for later completion. Information and/or rules from a patient list and/or other functionality 130 and/or data store 120 may be used to automate and/or customize order entry, for example. For example, patient insurance information, allergies, treatment instructions, laboratory results, etc., from a patient record and/or results review may automatically be inserted into an order entry form. Thus, physician, nurse, and/or other healthcare practitioner time may be saved though automated completion of order entry and/or other forms using information from the data store 120, other functionality 130, and/or user interface 110, for example. Additionally, information from an order entry may be passed to a medication or prescription management application for requesting and/or filling of a prescription or other medication order for a patient, for example. Furthermore, careless errors may be reduced though automatic completion of order entry and/or other forms, for example.

2. Results Review System

Certain embodiments of the present invention provide for user-configurable results review and reporting. Certain embodiments provide for a system and method for configuration and/or customization of results reporting.

In an embodiment, results may be categorized. There are many variables, such as, for example, white blood cell count (WBC) and potassium. A user may categorize results based at least in part on variables. A user may be, for example, a physician, nurse, or administrator. A view may be created with based on categories. Categories may be defined. Categories may be added to views. Subsets may be defined in a category. A user may pull up the view and see the categories. Categories may be populated for a patient. Terminology for the results may be specific to a given user, group of users, or site, for example.

Categories may be displayed according to a view. Categories and/or views may be defined based on, for example, a user, type of user, role, system, and/or site. An administrator may specify possible results for a particular lab test (category), for example. There may be, for example, a view for blood work and/or a view for notes. Users may go from a high level view down to details. For example, there may be a summary mode, a trend view, and a detail view. For example, the summary view may be time-compressed for a week. As another example, a user can select to view a trend or drill down to a specific value to show data on it. As another example, the user may pull up a note with the results and/or pull up an order form based on the data. A results view may show, for example, lab results, vitals, and notes. A results view may also show fluid values, lab values mapped against fluids going in and out, and comparison studies, for example. A user may view trends and/or comparisons for a patient and/or across patients, for example. In an embodiment, temporary and/or varying views may be created while reviewing data.

In an embodiment, the results review system may chart and/or graph data. Values may be graphed in comparison with, for example, each other, on the fly. A user may select items, values, data, and/or categories to be charted and/or graphed. A user may select a range of values, types of values and/or data. A user may select items for the graph and/or chart and may, for example, move over or highlight other items to view a dynamic/changing graph showing the selected items compared with or overlaid with the highlighted items. A user may zoom, pan, follow, and/or magnify data on a graph, for example. A user may adjust axes and data ranges based on, for example, the data being graphed. Axes and/or data ranges may be adjusted automatically based on, for example, the data being graphed. The view and/or scope may be adjusted based on the data in one or more of the graphed/charted results. The graph or chart may include a comparison value for a “normal” range or other comparison data, for example. For example, normal blood count may be shown along with the patient's blood count. As another example, temperature may be graphed in relation to blood count over time to see, for example, a correlation, trend, response to medication or other treatment. A user may normalize data for graphing. For example, a user may wish to see percentages as opposed to absolute values. The chart or graph may be used to see trends, panic and/or abnormal results, aid in diagnosis, treatment, effectiveness of treatment, to generate reports, and/or to graph across time.

In an embodiment, an indication may be given of, for example, normal results, abnormal results, and/or critical results. For example, the indication may be graphical, such as an icon. The user may select the indicator to obtain more information. For example, the user may click on an icon to see details as to why a result was abnormal. The user may be able to view only certain types of results. For example, the user may view only critical results.

Filters and/or rules may be provided for views and/or categories. Ranges, such as values or dates, may be specified for data. Default views, categories, filters, rules, and/or ranges may be provided. In certain embodiments, default values may be modified by a user and/or based on operating conditions. In certain embodiments, new views, categories, filters, rules, ranges, etc., may be created by a user.

For example, a filter may be used to filter medical results data presented to a user according to one or more variables. For example, when a filter is selected by a user, a modification routine applies the filter to the results displayed to the user in the current view by removing from display all medical results that do not fall within the filter. As described above, a variable may be any data or information included in medical data. For example, a variable may include one or more of a type (or item) and/or range of laboratory test results, vital sign measurements, fluids administered to a patient, and/or fluids measured from a patient. A variable may include text from notes, laboratory reports, examination reports, one or more captions to a laboratory test result, vital sign measurement, and/or fluids administered to/measured from a patient, an order for a laboratory test, treatment and/or prescription, and/or a name. By specifying one or more limits on one or more variables, a user may create a filter to be applied to results presented in a results window.

In an embodiment, a filter is a time-based filter. For example, a filter may be created that causes only results that have been updated to a computer-readable storage medium since a user last accessed the results data. In another example, a user may specify an initial date from which to present all results obtained after that date.

Filters may be created dynamically, or while a user is reviewing data. Filters may also be created and saved for later use. For example, a user may create a filter and communicate the filter from a computing device to a modification routine. The modification routine may then cause the filter to be saved at data store 120 and/or some other computer readable storage medium.

Filters may also be previously defined. For example, a first user may create a filter that is later retrieved from a memory (such as data store 120 or a computer readable storage medium) by a second user and applied to medical results presented in a results window.

In an embodiment, certain results, categories, and/or views may be blocked or protected. This may be based at least in part on a user, a type of user, a role, or tests. For example, HIV test results may be hidden except from a patient's physician.

In an embodiment, a report may be generated for an item, category, and/or value, for example. The user may view orders for a report and/or report results. Contents and/or format of a report may be provided as one or more defaults for a user and/or may be modified or created by the user, for example.

The data for the results may come from a lab, radiology, and/or an examination, for example. In an embodiment, any results on a patient may be viewed in the results view. As an example, a user may pull up the actual radiology report done by the radiologist.

In an embodiment, results, notes, and/or reports may be connected by criteria such as, for example, date. The results report may indicate if data or a note was changed and/or connected, for example. As another example, the report may indicate that comments were added to the data.

In an embodiment, results may be sorted. For example, results may be sorted by date and/or category. As another example, results may first be grouped by date and then by category (e.g., Day 1 and Categories A and B). As another example, results may be grouped first by category and then by date (e.g., Category A and Days 1 and 2). In an embodiment, results, values and/or categories may be displayed in a tree structure. In an embodiment, data, values, categories, and/or results may be filtered. For example, data may be filtered based on date. As another example, a physician's last review may be recorded and on subsequent viewing, initially only values that have been added and/or changed since that date may be displayed. As another example, a user may specify an initial date from which to display results.

In an embodiment, some or all of a clinical description for a patient may be shown. In an embodiment, some or all of the chronology of a patient may be shown.

In an embodiment, one or more of the icons, colors, and/or properties may be configurable. These may be modified for a particular environment or needs, for example.

In an embodiment, a configurable results review system may allow automatic update of components, rules and data transparently to a user. That is, results may be updated automatically with no action by the user. In an embodiment, the new results are pushed to the results review system. In an embodiment, the new results are polled by the results review system. In an embodiment, selected categories and/or items may be loaded with relevant data. In an embodiment, a user may view what results came in with the data requested in the report.

In an embodiment, a user may switch between patients. A user may use, for example, a drop-down list or other menu to select a patient. In an embodiment, options, selections, and/or configurations may be carried over between patients.

In certain embodiments, results review may be configured based on patient information and/or other information from functionality 130, data store 120, and/or user interface 110, for example. In certain embodiments, information for a patient from results review may be transferred manually and/or automatically to populate an order entry form or configure an order entry form for later completion. Additionally, information and/or rules from a patient list and/or other functionality 130 and/or data store 120 may be used to automate and/or customize results review and/or reporting, for example. For example, patient insurance information, allergies, treatment instructions, laboratory results, etc., from a patient record and/or orders may automatically be used to configure results review for the patient. Thus, physician, nurse, and/or other healthcare practitioner time may be saved through automated configuration of results review and/or report generation using information from the data store 120, other functionality 130, and/or user interface 110, for example. Additionally, information from a report or results review may be passed to a medication or prescription management application for requesting and/or filling of a prescription or other medication order for a patient, for example.

3. Patient Lists

Certain embodiments of the present invention provide for a user-configurable patient list. A patient list may be customized and/or configured based on the role of the user. For example, a nurse may see what patients are on his or her floor. As another example, a doctor may see patients in the entire healthcare facility. The patient list may be configured based on a variety of criteria, such as, for example, floor, room, unit, and/or type. The patient list may be configured to allow access to a variety of information and/or functionality based on, for example, the user, type of user, or site. Access may include, for example, order review, a document viewer, and order entry. Access to certain information may be restricted based on, for example, permissions configured for the user, authentication, specific user, type of user, or site. In an embodiment, the patient list displays data to which the user has access.

In an embodiment, the user may build a custom patient list. For example, different icons may represent different types of lists, such as criteria-based lists, user-based lists, and room-based lists. A user may create or define their own patient list. A user-based list may be, for example, a list particular to a specific physician. Certain columns of the patient list may be edited by the user. A user may assign values to columns directly from the patient list. For example, a user may specify the attending physician for a patient in the attending physician column of the patient list. The patient list may be configured to specify which columns may be edited by the user.

The amount of information displayed in the patient list may vary based on, for example, the user. As an example, a nurse may only be provided minimal information, whereas a physician may be provided all of the information available for the patients in the list. The information displayed in the patient list may be configured by an administrator or a user, for example. The information displayed in the patient list may be pre-configured or dynamically configured.

In an embodiment, the user may search the patient list by, for example, first name, last name, visit, record number, physician, and unit. The search may be done without creating a new patient list. The search criteria may be configured to show up on the patient list itself. The criteria that may be searched may be limited based on, for example, user, role, and patient. Searchable criteria may be configured. Access to searchable criteria may be based on, for example, particular users or types of users. A patient list may be created by, for example, selecting patients of interest based on criteria and saved as a patient based-list.

In an embodiment, indicators, such as icons, may be used in the patient list to notify a user that there are, for example, notes, abnormal lab results, normal lab results, panic lab results, and/or new orders. A user may select an icon to go to more detailed information regarding whatever the icon represents. For example, selecting an icon indicating there are notes for the patient would display the notes associated with the patient.

In an embodiment, the patient list may be organized by patient visit. For example, one row may represent one visit of a patient. The patient list may display a chronological history of patient visits. The user may display repeat visits and drill down/select an entry to show details of those visits.

In an embodiment, the patient list may be configured to show what is new since a prior point in time. New information may include, for example, new patients on the list, new lab results, and new orders. The prior point in time may be, for example, a fixed period (e.g., 1 day) or since the user last viewed the list.

Certain embodiments provide for patient privacy. A patient list may be formatted for HIPAA compliance. A patient list that supports privacy may be based on, for example, a pre-configured list of columns. A user may select data columns from an available list to provide patient privacy. A patient list may be requested, defined, declared, and/or selected to be deidentified. That is, the patient list may not show identifying information for a patient. In certain embodiments, patient information may be capable of re-identification for authorized persons.

Certain embodiments provide for a dynamically updateable and modifiable patient information center linking an up-to-date patient list with a variety of related resources. For example, the screen may dynamically refresh based on a change in the data. The patient list may always display the latest data. For example, an individual column may be updated when a new lab results is available for a patient. The data for the patient list may be pushed to the patient list rather than polled. For example, individual data may be updated by pushing the data to the patient list. In an embodiment, no user interaction is required to refresh the patient list. In an embodiment, the patient list may be updated based on a user request and/or periodically.

In certain embodiments, a patient list may serve as a launching point for access to other functionality 130 and/or data 120, for example. The user interface 110 may display a patient list and allow a patient to be selected from the list to display patient information and/or access one or more applications based on the patient, for example. Information for the patient stored in the data store 120 and/or input via the interface 110, for example, may be used to launch, modify, and/or populate one or more of the functionality 130, for example.

Patients may visit a hospital or other healthcare facility multiple times. Each visit may have a unique reason, but healthcare providers such as nurses and clinicians may want to access patient information associated with one or more earlier visits. Access to this information may allow the healthcare provider to provide better care to the patient. An application such as Census may be used to display patient information. Certain embodiments of the present invention allow a user to display information about a patient and their visits to healthcare facilities.

In an embodiment, to access the prior visit, a user may select a menu option. For example, a user may right-click on a patient that is displayed on a census. This action may launch a pop-menu. This pop-up menu may have an item named, for example, “Show All Patient Visits.” In an embodiment, when a user requests access to information about one or more prior visits, that information may be displayed. The information may be displayed in a new screen. The information may be displayed in the same window. In an embodiment, this information may be displayed in a tabular format. For example, each row on may represent a prior visit for a given patient.

In an embodiment, a user may select the prior visit from a list. In an embodiment, upon selection, the user may be given access to information about the patient. For example, the patient information may include one or more of: lab results, orders information, flowsheets, admission information, assessments, allergies, and/or problems. The patient information may be displayed in a new screen or window. The patient information may be displayed in the same window or screen.

In certain embodiments, a patient list may be configured based on patient information and/or other information from functionality 130, data store 120, and/or user interface 110, for example. In certain embodiments, information for a patient from a results review, order entry, prescription, electronic medical record, etc., may be transferred manually and/or automatically to populate and/or configure a patient list. Additionally, information and/or rules from functionality 130 and/or data store 120 may be used to automate and/or customize patient list content and/or format, for example. Thus, physician, nurse, and/or other healthcare practitioner time may be saved through automated configuration, populating and updating of a patient list using information from the data store 120, other functionality 130, and/or user interface 110, for example. Additionally, information from a patient list may be passed to a medication or prescription management application, an order entry application, a results review or reporting application, etc.

4. Clinical Decision Support

In certain embodiments, clinical decision support may be configured and/or impacted based on patient information and/or other information from functionality 130, data store 120, and/or user interface 110, for example. In certain embodiments, information for a patient from functionality 130, data store 120 and/or user interface 110 may be transferred manually and/or automatically to determine rules and/or information used to provide decision support to user. Additionally, information and/or rules from functionality 130 and/or data store 120 may be used to automate and/or customize clinical decision support, for example. For example, patient information and orders may influence clinical decision support provided to a user with respect to the patient. Thus, physician, nurse, and/or other healthcare practitioner time may be saved through automated configuration of clinical decision support using information from the data store 120, functionality 130, and/or user interface 110, for example. Additionally, information from clinical decision support may be passed to other functionality 130 and/or data store 120, for example.

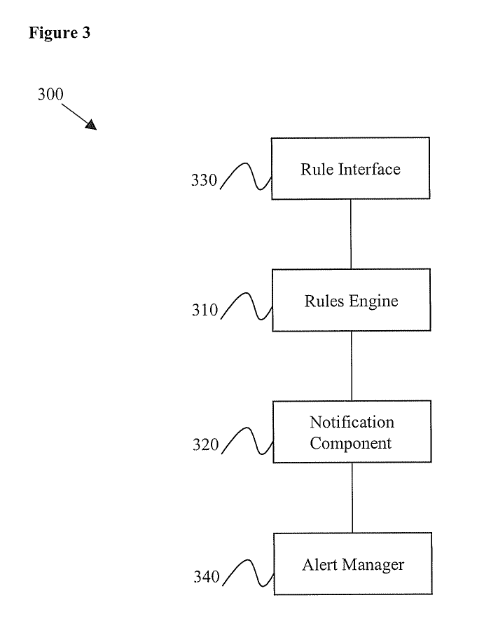

FIG. 3 illustrates a system 300 for clinical decision support used in accordance with an embodiment of the present invention. The system 300 includes a rules engine 310 and a notification component 320. In certain embodiments, the system 300 includes a rule interface 330. In certain embodiments, the system 300 includes an alert manager 340.

The rules engine 310 is in communication with the notification component 320. If present, the rule interface 330 is in communication with the rules engine 310. If present, the alert manager 340 is in communication with the notification component 320.

In operation, the rules engine 310 receives message data. The message data may be received from, for example, a pharmacy system, a lab system, an order management system, an admission discharge transfer (ADT) system, RIS, PACS, LIS, EMR, and/or other parts of a hospital information system (HIS). The message data may be received over a computer network or other communications interface, for example. The message data may conform, at least in part, to the HL7 protocol or other communications protocol, for example. The message data may indicate, for example, a lab result has become available for Patient A. As another example, the message data may indicate an x-ray procedure has been ordered for Patient B.

The rules engine 310 processes and/or evaluates the message data based at least in part one or more rules. In an embodiment, one or more rules are user-configurable. That is, the rule(s) may be configured, adjusted, and/or modified by a user. In an embodiment, the rule(s) is/are user-defined. That is, the file(s) may be created, defined, and/or specified by a user. Alternatively, one or more rules may be automatically configured using software, for example. A user may be, for example, an administrator, physician, nurse, or other healthcare provider.

A rule includes a condition component and an action component. The condition component of the rule is evaluated by the rules engine 310. If the rules engine 310 determines that the condition component of the rule is met, the rules engine 310 may then determine that the action component is to be effected. For example, a rule may include “if patient's potassium level drops by ten percent, then page patient's attending physician.” In this example, the conditional component is “patient's potassium level drops by ten percent” and the action component is “page patient's attending physician.” This rule may be evaluated when a lab result is received at the rules engine 310, for example. It should be understood that either or both of the condition component and the action component may be substantially more complex than this example; this example is simplified for clarity. As another example, a rule may include “if a patient's heart rate is less than 60 beats per minute AND the patient is taking the medication Digoxin, then page the attending physician AND flag all Digoxin orders on the patient's order review screen.” This rule illustrates a variety of condition component and action component capabilities, including, for example, evaluating a patient's medication and flagging orders related to the patient.

The condition component may include several factors and/or variables to be evaluated with various dependencies between them. Dependencies may include, for example, Boolean operators such as “AND,” “OR,” and “NEITHER.” The condition component may include a variety of conditions specified by an expression or operator such as “equal to,” “less than,” “greater than,” “drop by %,” and “increased by.” In addition, an expression or operator included in the condition component may include a temporal characteristic. For example, the expression might be “within the past hour” or “over one day ago.”

The action component may include a variety of options and/or events to be effected by, or initiated by, the rules engine 310. For example, one or more users may be notified and/or a user may be notified by different media depending on the determination of the rules engine 310. Thus, for example, the action component may indicate that the treating physician be paged and the referring physician be emailed unless the referring physician is in the hospital, in which case the referring physician may also be paged. The action component may at least in part be affected by the rules engine 310 initiating a notification using a notification component, for example. The notification component may be similar to notification component 320, described below, for example. In certain embodiments, the action component includes writing one or more orders. For example, if the patient's potassium level has dropped by ten percent, the action component may include writing an order to re-test the patient's potassium level in addition to paging the patient's attending physician.

A rule may be implemented as a table, interpreted code, database query, or other data structure, for example. A rule may be represented in a variety of ways known to one having ordinary skill in the art. A rule may be implemented as content in a database, for example. The database may store, for example, a rule type, criteria, operator, and value. The database may contain a rule identifier with one to many criteria pairs such as “criteria=Potassium, operator=drops, value=10%,” for example.

A rule may be specified at the site level. For example, one or more rules may be defined for a site, such as a clinic or hospital, that relate to general operating procedures. As an example, a rule, similar to the rule discussed above, may be specified to monitor the potassium level for all patients. A rule may be defined for a specific patient and/or group of patients. For example, one or more rules may be defined that are specific to a particular patient. As another example, one or more rules may be defined that are specific to a group of patients, such as those in an intensive care unit (ICU). These more specific rules may have condition components that are targeted to the particular condition and/or situation of the particular patient or group of patients. It should be noted that rules that are more general in nature may still be triggered on a per-patient basis. That is, for example, a general rule relating to potassium levels will still be evaluated in the context of each individual patient. More specific rules may only be evaluated in the context of patients that fit within the constraints of those rules. For example, a rule specific to patients in the ICU may not be evaluated for patients not in the ICU. In an embodiment, a rule may be specific to a user, such as a physician or other healthcare practitioner, or a group of users. For example, a rule may be specified so that a practitioner is notified by a page whenever lab results are available for any patient's assigned to that practitioner.

The rules engine 310 may process rules asynchronously and/or synchronously. An example of an asynchronously processed rule is a surveillance alert. An example of a synchronously processed rule is a real-time alert during an activity. An asynchronous rule is processed when data comes into the system 300. For example, when a lab value decreases and/or falls below a threshold, a rule is processed asynchronously, without a user being logged into the system. In contrast, a synchronous rule is processed while a user is utilizing the system. For example, a rule may prevent a user after a certain time from ordering an exam as “stat” as there may be no one available to process such an exam.

The notification component 320 is capable of notifying one or more recipients. A recipient may be notified by one or more media. For example, a recipient may be paged and/or emailed. As another example, a recipient may be a software module or program. As another example, a recipient may be a component and/or device such as an alert inbox or message manager. The alert inbox may be similar to alert inbox 340, described below, for example. The notification component 320 may notify a recipient in response to a request and/or initiation from the rules engine 310, for example. The notification to the recipient may include information based at least in part on information from the rules engine 310, for example. For example, the notification may include a patient's name, information about the condition component that was evaluated by the rules engine 310, and/or the evaluation of the condition component that resulted in the initiation of the notification. For HIPAA compliance, certain notifications may not include much information. For example, a message to alert inbox 340 may be displayed in a public area, depending on where a user is logged in. In this case, the notification and/or alert inbox 340 may, based on the location where the alert is being displayed and/or may be displayed, may only include a patient record number and a message to review the patient's results. As another example, a page directly to a physician may include a patient's name and a description of what the notification is regarding. The data in a notification may vary depending on the rule, for example.

The notification may be based at least in part on a notification template, for example. For example, the action component may include a notification template for the notification. The notification template may specify and/or describe the form and/or format the notification should take. The form and/or format may vary based on the medium of the notification. For example, the notification template may specify the format of an email to be sent and/or the format of a textual and/or aural page.

In an embodiment, the notification from the notification component 320 may take into account HIPAA, privacy, and/or confidentiality parameters. Based on the user accessing and/or viewing the information, only an alias and/or patient identification number may be provided, for example. For example, an email or pager notification, which may be communicated over an insecure network, may only include a patient identification number and/or alias. As another example, an alert sent to an internal hospital alert inbox, which may have more secure access capabilities, may include more details pertaining to the patient's identity and/or condition.

In certain embodiments, a rule interface 330 is present. The rule interface 330 allows a user to define, specify, create, modify, adjust, display, cancel, suspend, override, and/or remove one or more rules included in the rules engine 310. For example, an administrator may define a new rule to be applied to all patients using rule interface 330. As another example, a physician may suspend or override a rule from being evaluated for a particular patient because of the patient's particular condition or circumstances. In an embodiment, the rule interface 330 includes at least in part a point and click and/or graphical interface component. For example, the rule interface 330 may allow a user to build a rule by selecting factors and/or variables to evaluate. As another example, the rule interface 330 may allow a user to drag and drop connections between factors and/or variables to specify a rule. In an embodiment, the rule interface 330 provides one or more rule templates for creating rules. The rule template may define and/or specify a structure for a rule. That is, the rule template may include a basic set of conditions and/or actions useful for a particular category of rules. The rule template may include a condition component and/or an action component. For example, a rule template may be provided for checking lab results. The user may select the rule template, and then specify the particular lab result and deviation from prior results and/or a standard value, for example.

In certain embodiments, the rule interface 330 restricts what a user may do with a rule, or the creation of a rule, based at least in part on the identity of the user. That is, a particular user may only have privileges to create, access, modify, and/or remove particular rules. For example, a nurse may only be able define a rule for a patient under the nurse's care. As another example, a physician may be able to modify a rule for any patient. As another example, an administrator may be able to create a new site-wide rule that is evaluated for all patients.

In certain embodiments, an alert manager 340 is present. The alert manager 340 may be similar to an “inbox” and/or notification manager, for example. The alert manager 340 may be a user interface and/or software, hardware, and/or firmware component that allows a user to manage alerts and/or notifications, for example. The notifications may be received from the notification component 330, described above, for example. A user may be a physician, nurse, or other healthcare provider, for example. Managing alerts and/or notifications may include filtering and/or ordering received alerts and/or notifications, for example. For example, a physician may sort notifications from the notification component 330 with the alert manager 340 by order received. As another example, a physician may filter alerts and/or notifications with the alert manager 340 based on severity, e.g., only showing the highest priority alerts and/or notifications. In certain embodiments, the alert manager 340 is capable of allowing a user to acknowledge and/or respond to one or more notifications and/or alerts. For example, a radiologist may receive a notification that a patient's chest x-ray is available to be read. The physician may acknowledge receipt of the notification with the alert manager 340.

In certain embodiments, the system 300 includes a processing component (not shown) for episode management. The processing component is in communication with the rules engine 310. In an embodiment, the processing component is in communication with the notification component 320. Episode management includes monitoring and/or tracking data pertaining to a patient and/or group of patients from the detection of a problem until the resolution the problem. The processing component may track a treatment plan, medication given, and how a patient is responding based at least in part on message data. Episode management may span across encounters between a patient and a healthcare provider, for example. In certain embodiments, the processing component is included in the rules engine 310.

The components and/or functionality of system 300 may be implemented alone or in combination in hardware, firmware, and/or as a set of instructions in software, for example. Certain embodiments may be provided as a set of instructions residing on a computer-readable medium, such as a memory, CD, DVD, or hard disk, for execution on a general purpose computer or other processing device, such as, for example, a PACS workstation.

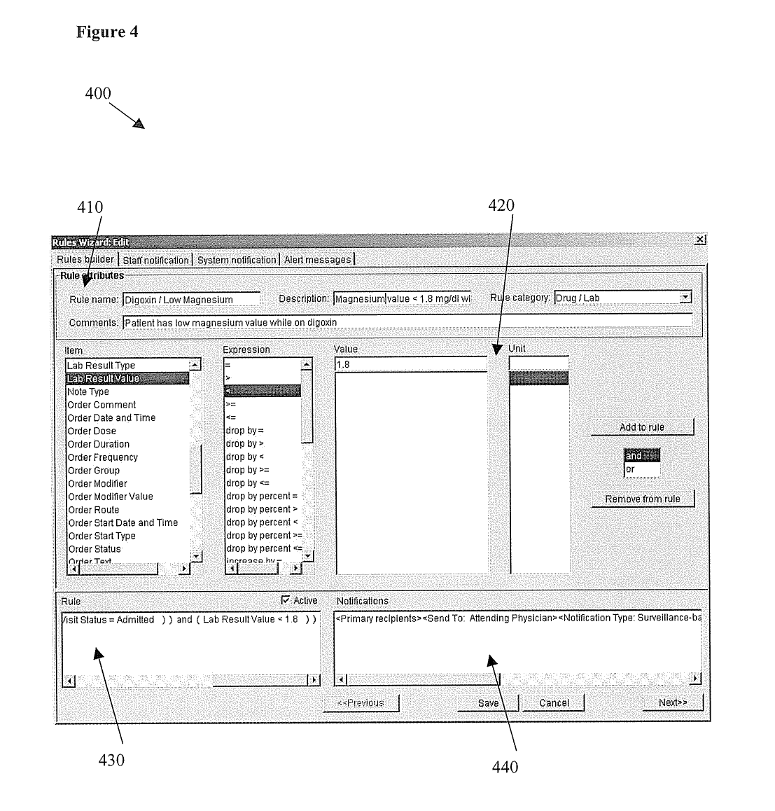

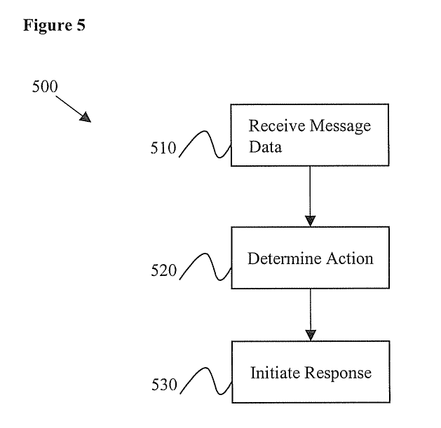

FIG. 4 illustrates an interface 400 for rule management used in accordance with an embodiment of the present invention. Interface 400 may be similar to rule interface 330, described above, for example. For the purposes of the following discussion, interface 400 will be described with capabilities similar to rule interface 330, described above. However, it would be known to one having ordinary skill in the art that other implementations are possible.

As discussed above, interface 400 may be configured to allow a user to create, define, manipulate, adjust, alter, activate, deactivate, cancel, remove, and/or delete one or more rules in a variety of different ways and layouts. A rule and/or components of a rule may be presented, for example, as text, in a table, list, chart, and/or other graphical format. Interface 400 may be configured to allow a user to point and click at least in part to create and/or modify a rule. It should be emphasized that the following discussion of interface 200 is as depicted in FIG. 2, but that other implementations, layouts, and displays are possible and would be known to one having ordinary skill in the art.

The interface 400 includes a rule attribute panel 410, a rule configuration panel 420, a rule condition panel 430, and a rule action panel 440. The following discussion of the operation of interface 400 refers to creating a new rule, but modification of an existing rule would be similar and would be understandable by one having ordinary skill in the art based on the following description.

In operation, a user may specify attributes for a rule. Attributes may be specified using the rule attribute panel 410. Attributes may include, for example, a rule name, a description, comments, and/or a category. The category may be used to organize rules, for example.

The user may specify the rule condition component and/or action component for a rule. The condition component and/or action component may be specified using the rule configuration panel 420. For example, the rule configuration panel 420 may include lists, tables, icons, and/or other controls for defining the condition and/or action components of a rule. The rule configuration panel 420 may include a list of items, factors, and/or variables to be evaluated and/or tested as part of the condition component for a rule. For example, a list may include “potassium lab result” as a variable to be used in the condition component of a rule.

The rule configuration panel 420 may allow a user to specify an operator or expression for use in evaluating the item, factor, and/or variable. For example, a list may include “drop by %.” Operators and/or expressions may include, for example, Boolean operators such as “AND,” “OR,” and “NEITHER,” for example. As another example, the operators and/or expression may include a variety of conditions specified by an expression or operator such as “equal to,” “less than,” “greater than,” “drop by %,” and “increased by.” In addition, an expression or operator may include a temporal characteristic. For example, the expression might be “within the past hour” or “over one day ago.”

The rule configuration panel 420 may allow a user to specify a value to be evaluated in the context of the specified factor or variable and the specified operator or expression. For example, a text entry box may allow the user to specify “10” in the context of the above discussed examples, yielding a condition component that specifies “potassium lab result drop by 10%.”

The rule configuration panel 420 may allow a user to specify units for the value. For example, if, instead of a 10% drop, a drop of 1.2 mg/dl was the desired triggering condition, the units for the value may be specified.

Multiple items, factors, and/or variables may be added to the rule being specified using the rule configuration panel 420. For example, the rule may include several factors and/or variables to be evaluated with various dependencies between them. Dependencies may include, for example, Boolean operators such as “AND” and “OR.” Another operator may be the “EXISTS” operator, for example. The “EXISTS” operator may be used to determine if, for example, an order exists or if a patient has a particular allergy.

The rule interface 400 allows a user to specific a variety of options and/or events to be affected or initiated when the condition component is met in the action component of the rule. For example, one or more users may be notified and/or a user may be notified by different media. Thus, for example, the action component may indicate that the treating physician be paged and the referring physician be emailed unless the referring physician is in the hospital, in which case the referring physician may also be paged. In certain embodiments, the action component includes writing one or more orders. For example, if the patient's potassium level has dropped by ten percent, the action component may include writing an order to re-test the patient's potassium level in addition to paging the patient's attending physician.

The current form of the condition component of the rule being specified may be displayed in the rule condition panel 430. The current form of the action component of the rule being specified may be displayed in the rule action panel 440.

The components and/or functionality of interface 400 may be implemented alone or in combination in hardware, firmware, and/or as a set of instructions in software, for example. Certain embodiments may be provided as a set of instructions residing on a computer-readable medium, such as a memory, CD, DVD, or hard disk, for execution on a general purpose computer or other processing device, such as, for example, a PACS workstation.

FIG. 3 illustrates a flow diagram for a method 500 for clinical decision support used in accordance with an embodiment of the present invention. The method 500 includes the following steps, which will be described below in more detail. At step 510, message data is received. At step 520, an action is determined. At step 530, a response is initiated. The method 500 is described with reference to elements of systems described above, but it should be understood that other implementations are possible.

At step 510, message data is received. The message data may be received at a rules engine. The rules engine may be similar to rules engine 310, described above, for example. The rules engine is capable of processing message data based at least in part on a rule. The rule may be similar to a rule included in rules engine 310, described above, for example. In an embodiment, the rule is user configurable. In an embodiment, the rule is user-defined. In an embodiment, the rule is defined and/or configured by software and/or an administrator, for example.

The message data may be received from, for example, a pharmacy system, a lab system, an order management system, an ADT system, RIS, PACS, LIS, EMR, and/or other parts of an HIS. The message data may be received over a computer network or other communications interface, for example. The message data may conform, at least in part, to the HL7 protocol or other communications protocol, for example. The message data may indicate, for example, a lab result has become available for Patient A. As another example, the message data may indicate an x-ray procedure has been ordered for Patient B.

At step 520, an action is determined. The action may be determined by a rules engine. The rules engine may be similar to rules engine 310, described above, for example. The action may be based at least in part on message data. The message data may be the message data received at step 510, described above, for example. The action may be based at least in part on a rule. The rule may be similar to a rule included in rules engine 310, described above, for example.

A rule includes a condition component and an action component. The condition component of the rule is evaluated by the rules engine 310. If the rules engine 310 determines that the condition component of the rule is met, the rules engine 310 may then determine that the action component is to be effected. For example, a rule may include “if patient's potassium level drops by ten percent, then page patient's attending physician.” In this example, the conditional component is “patient's potassium level drops by ten percent” and the action component is “page patient's attending physician.” This rule may be evaluated when a lab result is received at the rules engine 310, for example.

At step 530, a response is initiated. The response may be initiated by a rules engine. The rules engine may be similar to rules engine 310, described above, for example. The response may be initiated based at least in part on a determined action. The determined action may be the action determined at step 520, for example. The determined action may be based at least in part on a rule. The determined action may be based at least in part on the action component of a rule.

The response may include, for example, notifying one or more users. The response may include notifying a user by different media depending on the determination of the rules engine 310 based at least in part on a rule, for example. Thus, for example, the action component of a rule may indicate that the treating physician be paged and the referring physician be emailed unless the referring physician is in the hospital, in which case the referring physician may also be paged. The action component may at least in part be affected by the rules engine 110 initiating a notification using a notification component, for example. The notification component may be similar to notification component 320, described above, for example. In certain embodiments, the initiated response includes writing one or more orders. For example, if the patient's potassium level has dropped by ten percent, the initiated response may include writing an order to re-test the patient's potassium level in addition to paging the patient's attending physician.

In certain embodiments, a rule is defined with a rule interface. The rule interface may be similar to rule interface 330, described above, for example. The rule interface allows a user to define, specify, create, modify, adjust, display, cancel, suspend, override, and/or remove a rule. In an embodiment, the rule interface includes at least in part a point and click and/or graphical interface component. For example, the rule interface may allow a user to drag and drop connections between factors and/or variables to specify a rule.

In an embodiment, the rule is defined and/or specified based at least in part on a rule template. The rule template may define and/or specify a structure for a rule. That is, the rule template may include a basic set of conditions and/or actions useful for a particular category of rules. The rule template may include a condition component and/or an action component. For example, a rule template may be provided for checking lab results. The user may then select the rule template, and then specify the particular lab result and deviation from prior results and/or a standard value, for example. In an embodiment, the action component of the rule template includes a notification template.

One or more of the steps of the method 500 may be implemented alone or in combination in hardware, firmware, and/or as a set of instructions in software, for example. Certain embodiments may be provided as a set of instructions residing on a computer-readable medium, such as a memory, CD, DVD, or hard disk, for execution on a general purpose computer or other processing device, such as, for example, a PACS workstation.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

5. Medication Management

Certain embodiments of the present invention provide for the coding of additional pieces of information so some or all of the data may be parsed and understood by other systems. Other systems may include, for example, Medication Administration Record (MAR), Computerized Physician Order Entry (CPOE), and prescription (Rx) systems. In an embodiment, advanced orders may be placed that were not previously possible. For example, tiered or hierarchical orders including a plurality of related orders may be communicated via an advanced order for filing by a system. As another example, a single advanced order may include a plurality of related simple orders for processing. In certain embodiments, a change to one part of an advanced order is automatically reflected in all parts of the related advanced order. Certain embodiments of the present invention may allow details of advanced orders in a coded mechanism to be passed so that, for example, the CPOE application may execute appropriate interaction checking. For example, checks may be made for drug-drug interactions, dose range warnings, drug-allergy, duplicate drug, and therapeutic duplication. In an embodiment, a pharmacist may receive a partially or completely coded order. In an embodiment, the MAR may display these orders correctly for the administration of the doses.

In an embodiment, orders may be usable by other external applications, such as, for example, the Centricity Clinical Decision Support module or the order entry module, for use with other custom rules created by, for example, an administrator.

Certain embodiments of the present invention provide an interface to facilitate communicating more advanced types of orders. In an embodiment, the standard HL7 specification may be used for basic order details. In an embodiment, one or more additional custom segments may be utilized to provide advanced details. In an embodiment, coding and formatting for segments may be agreed upon allowing both sides to be able to decode a message and perform various actions.

The previous system would only write additional details, such as additives, to the comment section of the order, leaving it uncoded and unusable for interaction checking or the pharmacy system. Pharmacists would then need to build the order again in their system based on the comments. In an embodiment, additional details (e.g., additives) may be coded. In an embodiment, additional details may be used, for example, for interaction checking and/or by the pharmacy system.

In an embodiment, components may be made available to users such as, for example, the Complex Dosing screen, the Total Parenteral Nutrition (TPN) Order Administrator, and the Additives component. In an embodiment, these components may be placed on, for example, an order entry form which is assigned to a set of orders. In an embodiment, the application may store data from one or more components on the order object. In an embodiment, the application may commit to the database when the user clicks the save button, for example. In an embodiment, upon completing an order, the application may queue details in, for example, a database. The database may be monitored by, for example, the Centricity Interface Administrator (IA). The monitor (e.g., IA) may construct a message based at least in part on details retrieved from the database, for example. A message may be sent to a pharmacy system. In an embodiment, an application (e.g., a pharmacy application) may decode at least one of a message and advanced data. The application may build a suitable object. For example, a pharmacy application may build an object for use by a pharmacy. In an embodiment, the system may constrict a message back with, for example, changes to the data. This may occur when, for example, it has been verified and/or approved by, for example, a pharmacist. In an embodiment, an IA may then decode a message and update, for example, CPOE and MAR based at least in part on details coming back from pharmacy. In an embodiment, when an order has been at least in part verified in a pharmacy, the systems may have the order linked. A linked order may allow changes made in any of the systems to, for example, trigger an update to modify and/or update other systems with the new details, for example.

In certain embodiments, medication management may be configured and/or impacted based on patient information and/or other information from functionality 130, data store 120, and/or user interface 110, for example. In certain embodiments, information for a patient from functionality 130, data store 120 and/or user interface 110 may be transferred manually and/or automatically to help determine a prescription order for the patient. For example, patient information and orders may influence medication management with respect to the patient. Additionally, information from medication management may be passed to other functionality 130 and/or data store 120, for example.

6. Clinical Information Viewer

Certain embodiments of the present invention allow a user to indicate to the system that the session with the system should at least in part involve low-bandwidth communication. For example, when a user is connecting to a clinical information view (CIV) application via a slow connection, such as dial-up, he or she may desire a low-bandwidth session. This desire may be communicated to the system by, for example, a low-bandwidth checkbox on the CIV logon page. When this option is available at logon, for example, users may have the flexibility at the earliest point to choose which connection-speed strategy will work best for them. As an alternative, certain embodiments provide for specifying a user-selectable connection speed setting at logon. As another alternative, a connection speed may be specified at the system configuration level. Alternatively, the bandwidth available to the user may be determined at least in part automatically and/or based on previously specified preferences or sessions or configurations. In certain embodiments, information regarding the connection speed of the user to the system and/or the user's desire for a low-bandwidth session may result in at least one high-bandwidth application being replaced with a low-bandwidth application and/or adapted to provide low-bandwidth interaction.

In certain embodiments of the present invention, a low-bandwidth or constrained-bandwidth indication to the system may result in high-bandwidth features being turned off or replaced with lower-bandwidth alternatives and/or versions. That is, the low-bandwidth option may, for example, allow the user to opt for certain features which require high-bandwidth to function reasonably to be turned off in favor of low-bandwidth alternatives. For example, a Results Review Applet may be turned off in favor of the low-bandwidth-friendly Results Review Lite feature.

In an embodiment, under a normal fast-connection (e.g., high-bandwidth) usage, the user may switch between, for example, Results Review Lite and Results Review, but in low-bandwidth mode, only Results Review Lite may be available.

As an example, the Results Review Applet may require for a high-bandwidth connection to perform adequately. Under normal circumstances, when the user logs in, certain activities may start occurring in the background to initialize the data for the high-bandwidth Results Review Applet option. These may start to occur even before the user attempts to access Results Review. This may occur, for example, to give the user reasonable performance when they do access the feature. In an embodiment, with the low-bandwidth option indicated, these background activities may cease to occur, making the system perform more optimally, overall, under low-bandwidth conditions.

In certain embodiments, the system may be put into a low-bandwidth mode at the user level on the logon page using, for example, a low-bandwidth checkbox. In certain embodiments, the system may use a low-bandwidth mode when specified at the system level. In an embodiment, the system may be put into a low-bandwidth mode at later point in the session, after logon. In an embodiment, the low-bandwidth mode may, for example, disable the Results Review Applet. In an embodiment, when the system is configured to disable the Results Review Applet (e.g., low-bandwidth is the implied default behavior), then the low-bandwidth option may be omitted from the logon page and the system behaves in low-bandwidth mode by default, with no option to switch to the Results Review Applet.

In certain embodiments, the clinical information viewer may be configured and/or impacted based on patient information and/or other information from functionality 130, data store 120, and/or user interface 110, for example. In certain embodiments, information for a patient from functionality 130, data store 120 and/or user interface 110 may be transferred manually and/or automatically to configure the clinical information viewer for a user. Additionally, information and/or rules from functionality 130 and/or data store 120 may be used to automate and/or customize the clinical information viewer for a particular patient, for example. For example, patient information, orders and results may influence clinical information provided to a user with respect to the patient. Thus, physician, nurse, and/or other healthcare practitioner time may be saved through automated configuration of the clinical information viewer using information from the data store 120, functionality 130, and/or user interface 110, for example. Additionally, information from the clinical information viewer may be passed to other functionality 130 and/or data store 120, for example.

7. Workflow (Third Party Applications)

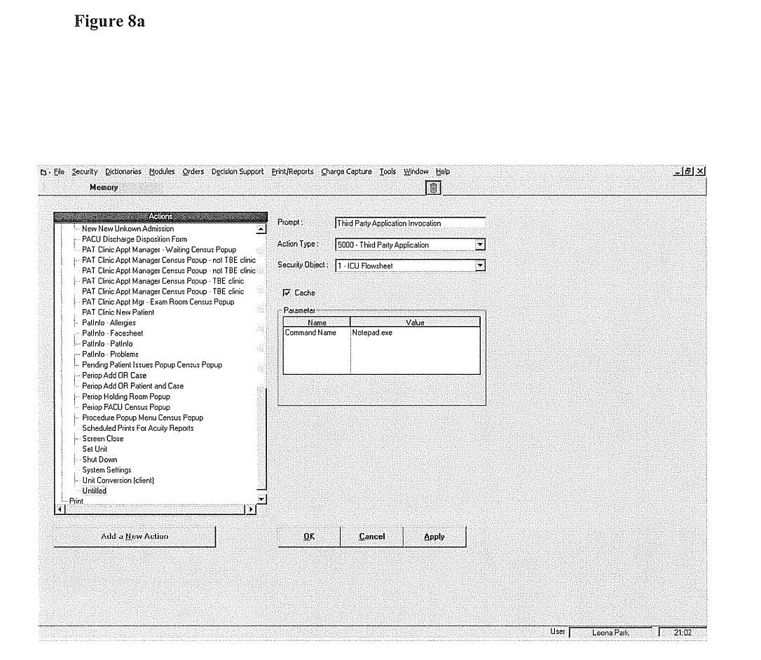

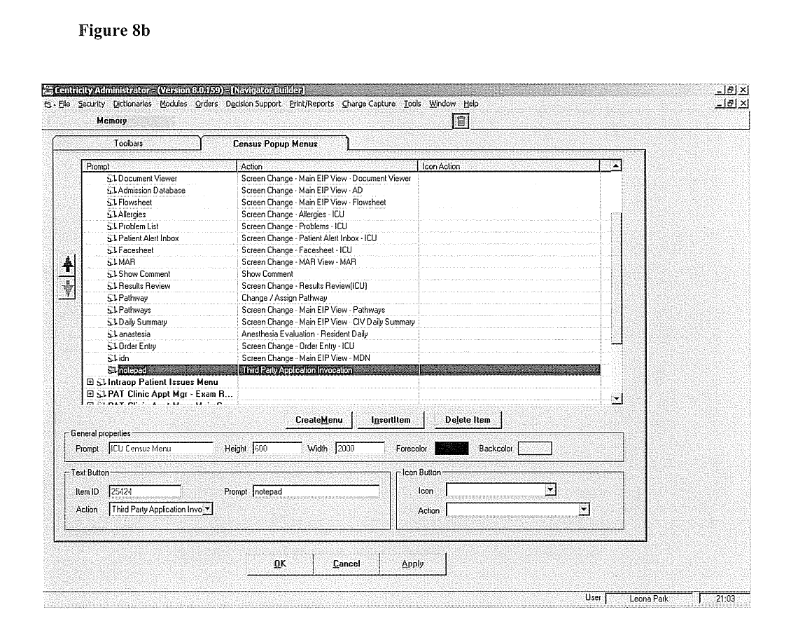

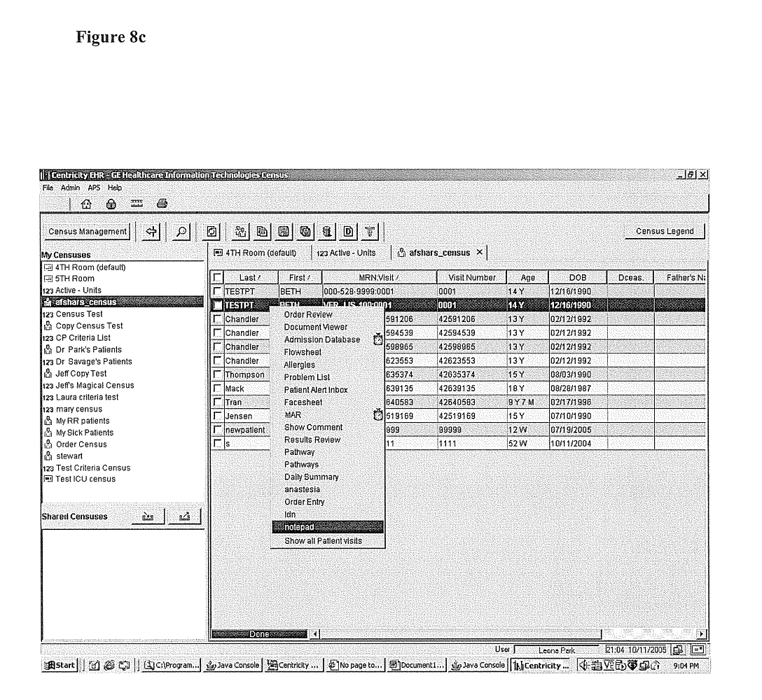

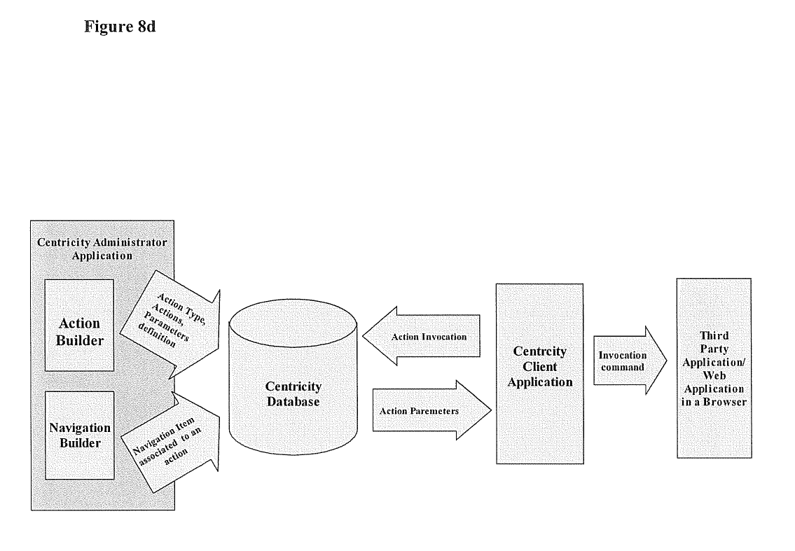

Certain embodiments of the present invention provide for a third party application (TPA) feature. The TPA feature seeks to conveniently launch a third party application. For example, the TPA may be launched with current clinical context being passed from the client application to the TPA. The client application may be a Centricity client, for example. While the end user may have previously had to manually launch a TPA, log in, pick the relevant patient and then navigate to the relevant screen, using this feature, they could do all of this with a single click. FIGS. 8a-8d illustrate exemplary third party application features used in accordance with embodiments of the present invention.

The TPA may be an executable application. The TPA may be a web application that can be launched using, for example, a URL. The TPA may be a link to another application. The TPA may be a completable form.

The TPA does not need to have any specific interface compliance. For example, the TPA does not need to comply with the Clinical Context Object Working Group (CCOW). In an embodiment, the TPA may be launched from the command line if it is, for example, an executable.

In an embodiment, the TPA feature receives a parameter string. The parameter string may be configurable. In an embodiment, the TPA feature may substitute values in the parameter string. For example, the TPA feature may substitute one or more of the following in the parameter string: user id, patient id, and/or encounter id. The substitute values used may be based at least in part on the context information that the client application has at the time of launching the TPA, for example.

In an embodiment, a user may configure one or more TPA applications to be launched, as needed, using an existing navigation framework. In certain embodiments, the TPA may be able to launch automatically to different clinical screens. This ability may be based, at least in part, on command line parameters supplied to the TPA. In an embodiment, the configuration ability for the TPA feature allows the user to create, for example, separate menu items to be able to launch to different clinical screens of the same TPA.

When a TPA is launched, it may exist as a completely separate application and may be used by a user as needed, for example. If the clinician is viewing data for a certain patient and then needs to review some other aspect of clinical information stored in a completely separate system, they can do so without having to go through multiple steps manually. In certain embodiments, a TPA launched in a given session is closed when user quits, exits, shuts down, or deliberately logs off from the client application. This may be done for security reasons, for example. In an embodiment, one or more TPAs may be kept open if the client application times out. This behavior may occur because the user may be using the TPA without any activity in the client application. In an embodiment, the TPA may not be shut down because the user may still be using it, even though the client application has timed out.

In certain embodiments, the parameter string used in part to launch the TPA or the URL used to launch the browser may be encrypted for further security. In certain embodiments, the TPA feature may be able to interpret the encrypted string and launch the TPA.

In certain embodiments, the TPA feature may be configured and/or impacted based on patient information and/or other information from functionality 130, data store 120, and/or user interface 110, for example. In certain embodiments, information for a patient from functionality 130, data store 120 and/or user interface 110 may be transferred manually and/or automatically to determine a TPA executed. Additionally, information and/or rules from functionality 130 and/or data store 120 may be used to customize parameters for a TPA, for example. Thus, physician, nurse, and/or other healthcare practitioner time may be saved through automated configuration of TPA using information from the data store 120, functionality 130, and/or user interface 110, for example. Additionally, information from TPA may be passed to other functionality 130 and/or data store 120, for example.

8. Patient Privacy/HIPPA/JCAHO

In certain embodiments of the present invention, patients may be marked as confidential in a variety of ways. For example, a flag may be received from the hospital's HIS system. The flag may come over ADT, for example. The flag may be received from a component of the HIS, for example. As another example, a patient may be marked as confidential in the system.

In an embodiment, when a patient is marked and/or flagged confidential, one or more staff members previously, currently, or subsequently assigned to the patient as, for example, caregivers, are granted access to the patient and/or the patient's data. Individual staff members, or groups of staff members, may be granted access to the patient. These individuals or groups may be granted access based at least in part on role, for example.

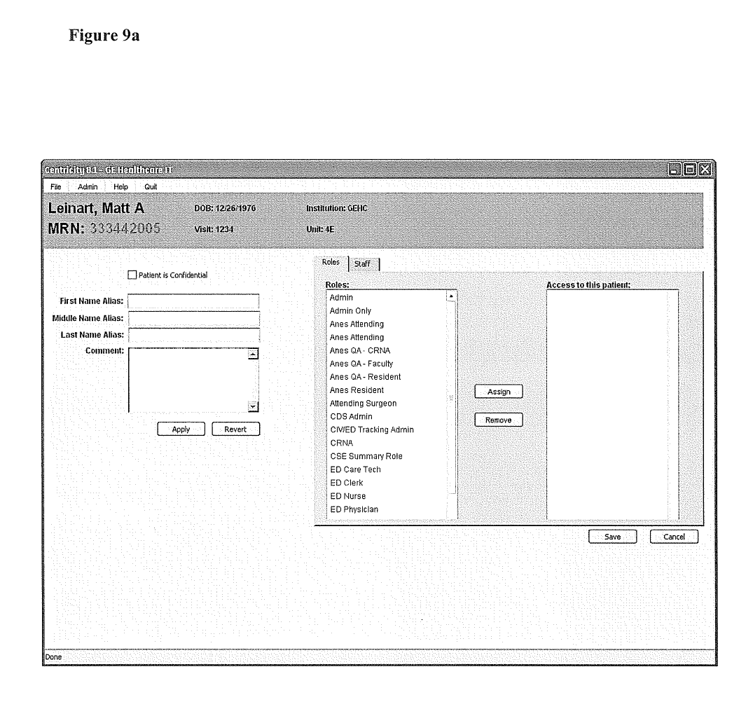

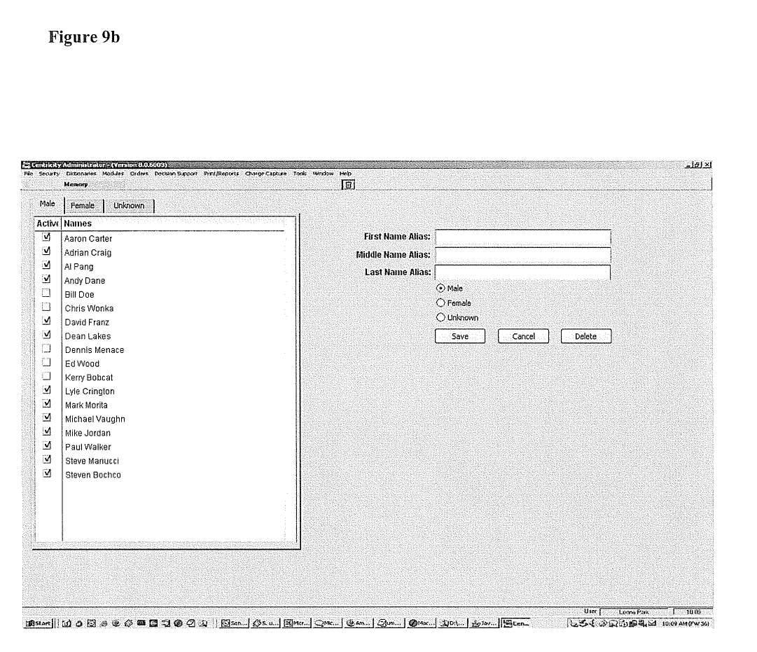

In certain embodiments, when a patient is marked as confidential, an alias name or identifier is assigned to the patient. In an embodiment, this name or identifier may be received along with the confidential flag. The name or identifier may be received over, for example, Admission Discharge Transfer (ADT). The name or identifier it may be auto-assigned. The auto-assigned name may come from, for example, a list of alias names that has been setup in the system. As another example, the auto-assigned name or identifier may be generated dynamically. FIGS. 9a-9b illustrate exemplary aliasing applications used in accordance with embodiments of the present invention.

In certain embodiments, a confidential patient may be displayed in the system using the patient alias instead of their real name. For example, users that have not been granted access to the patient may be shown the patient alias instead of the patient's real name. In addition, in an embodiment, only staff that have been granted access to the patient may open the patient's medical record.

In certain embodiments, when a patient has been marked confidential, the system may also control whether, for example, printing and/or reporting on this patient should use the patient's legal name or the alias or both. In an embodiment, this may be based at least in part on who is trying to print and/or access the record. In certain embodiments, the application may not return confidential patients when searching by, for example, legal name. In an embodiment, the system may allow searching by aliases.

In certain embodiments, privacy protection may be configured and/or impacted based on patient information and/or other information from functionality 130, data store 120, and/or user interface 10, for example. Additionally, privacy information may be passed to other functionality 130 and/or data store 120, for example.

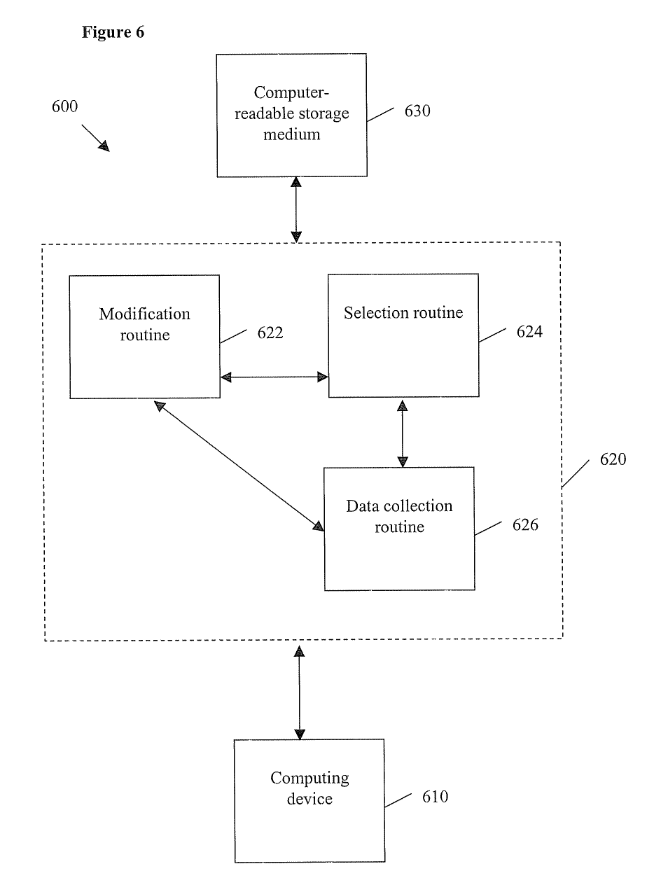

FIG. 6 illustrates a system 600 for patient and practice management in accordance with an embodiment of the present invention. The system 600 includes a computing device 610, a set of instructions 620 for said computing device 610, and a computer-readable storage medium 630.

The computing device 610 may be embodied in any apparatus or system capable of performing operations according to one or more sets of instructions. For example, computing device 610 may include a desktop computer, a handheld digital assistant (such as a Palm device), a computer workstation (such as that in a PACS system), or a laptop computer. Computing device 610 may include one or more output devices such as a display device, printer, and/or speakers. The display device may include a computer monitor, for example. Computing device 610 may include one or more input devices such as a mouse, stylus, keyboard, and/or microphone. While a single computing device 610 is shown in FIG. 6, system 600 may include multiple computing devices 610. In addition, while computing device 610 is schematically illustrated in FIG. 6 as comprising a single “box,” one having ordinary skill in the presently described technology will recognize that a computing device 610 may be embodied in multiple “boxes” collectively operating together to achieve one or more desired functions.

The set of instructions 620 may be embodied in one or more computer software applications. For example, set of instructions 620 may include one or more software modules or routines. Set of instructions 620 may include a modification routine 622, a selection routine 624, and a data collection routine 626, for example. Each of routines 622 through 626 may be embodied in a separate software application or may be partially or entirely grouped together in a software application, as recognized by one having skill in the presently described technology.

The set of instructions 620 are stored on one or more computer-readable storage media. A computer-readable storage medium may include an internal computer memory, a removable computer memory (such as a floppy disk, CD or DVD), or an external computer memory (such as memory in one or more servers accessible to computing device 610), for example. In an embodiment, the set of instructions 620 are stored on a computer memory internal to computing device 610. For example, set of instructions 620 may be stored on a computer hard drive of device 610. In another embodiment, set of instructions 620 are stored on a computer memory external to computing device 600. For example, set of instructions 620 are stored on a computer memory in a server accessible to computing device 610. In another embodiment, a portion of the set of instructions 620 are stored on a computer memory internal to computer device 610 and the remainder of the set of instructions 620 are stored oil a computer memory external to computing device 610.

Computer-readable storage medium 630 includes a computer memory such as that described above with regard to set of instructions 620. Medium 630 includes medical data, such as results from one or more medical examinations. In an embodiment, medium 630 is a different computer-readable storage medium on which set of instructions 620 is located. In another embodiment, medium 630 is the same computer-readable storage medium on which the set of instructions 620 is stored.

Computing device 610 communicates with set of instructions 620 over a wired or wireless connection. Computing device 610 also employs set of instructions 620 to carry out one or more steps of the technology presently described herein. Computing device 610 uses, or communicates with, one or more routines 622 through 628 of the set of instructions 620, to access and present medical results and data stored on medium 630. Therefore, medium 630 also communicates with or uses one or more routines 622 through 628 of set of instructions 620.

In operation, a user employs computing device 610 to access and view functionality and data stored at computer-readable medium 630. A user may be any individual, such as a doctor, physician, radiologist, nurse, or hospital administrator, for example. For example, data may include medical data including results from a laboratory test, measurements of a patient's vital signs, notes from a user (such as a doctor, physician, radiologist, nurse, or hospital administrator), current and/or past orders (such as prescription orders, laboratory orders, and/or treatment orders), laboratory reports, user reports, flowsheets (such as nursing flowsheets), and/or comparison studies (such as comparisons between results for a particular patient and/or across multiple patients).

In certain embodiments, a user may customize which functionality and/or data are presented to him or her and the manner in which the functionality and/or data are presented. In addition, system 600 may provide a comprehensive visual snapshot of one or more patients' statuses. A user initially logs on to system 600 by providing a user identity to computing device 610. For example, a user can provide a user ID and/or password. Once the user's user identity has been verified, the user can employ an input device connected to computing device 610 to select one or more patients whose data and/or related functionality the user wants to review. For example, the user can select one or more names from a list of patient names.

Once the user has selected one or more patient names, the user may select a mode of display. A mode of display is a manner of presenting functionality and/or data according to one or more views, or templates. A mode of display presents an interface or portal of functionality and/or data according to the mode and/or a view selected by the user.

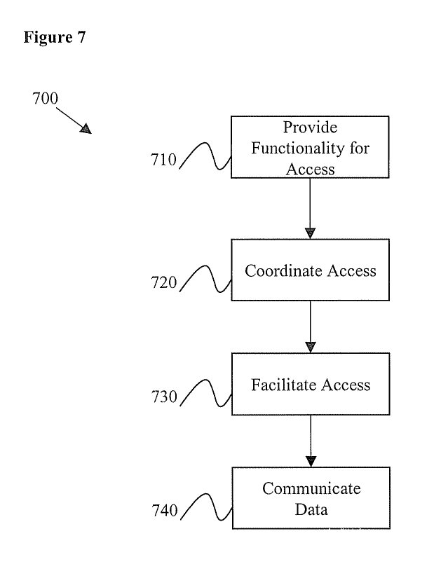

FIG. 7 illustrates a flow diagram for a method 700 for providing access to clinical functionality and data in accordance with an embodiment of the present invention. First, at step 710, functionality is provided for access by a user. For example, order form configuration, clinical order entry, medication management, and results review may be provided for access by a clinical user, such as a physician or nurse. At step 720, access is coordinated or “tied together” via a centralized access interface or portal for the user. For example, the variety of functionality and/or data is provided through a web portal for centralized access by a user. At step 730, access to the functionality is facilitated for a user. For example, selection of icon, list/menu item, command, etc., via the web portal triggers execution of the selected functionality for viewing and/or manipulation by the user.

At step 740, data is communicated between applications and other functionality. For example, data from a results review of laboratory tests for a patient may be communicated to an order entry application, medication management application, and/or third party application for compilation of an order or other action based on the results data. Alternatively and/or in addition, a plurality of applications may be executed simultaneously and/or in conjunction based on a user action via an interface. For example, a single command and/or selection by a user via the web-based portal may launch a clinical order entry, a prescription order, and a review of laboratory results for a particular patient.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for providing functionality and data for patient and practice management via a user interface, said method comprising:
interrelating a plurality of functionality related to at least one of patient care and clinical management;
facilitating access to said interrelated plurality of functionality via a coordinated user interface; and
delivering at least a portion of said interrelated plurality of functionality to a user.

2. The method of claim 1, further comprising routing data from a first functionality to a second functionality in response to access by said user of said first functionality.

3. The method of claim 1, further comprising customizing said coordinated user interface based at least in part on direction from a user.

4. The method of claim 1, further comprising allowing said user to enter data via said coordinated user interface.

5. The method of claim 1, further comprising dynamically adapting said coordinated user interface and said interrelated plurality of functionality based on said user.

6. The method of claim 1, further comprising allowing a user to define relationships between said plurality of functionality to facilitate automatic execution of related functionality and routing of data.

7. The method of claim 1, wherein said functionality comprises order entry functionality, results review functionality, clinical decision support functionality, medication management functionality, and patient listing functionality.

8. A user interface system for clinical applications and data, said system comprising:
a memory storing a plurality of functionality and data related to at least one of patient management and practice management; and
a user interface configured as a portal to said plurality of functionality, said user interface providing coordinated access to said functionality and data customizable by a user.

9. The system of claim 8, wherein said functionality and data are dynamically configurable based at least in part on input from a user.

10. The system of claim 8, wherein said user interface comprises a data entry interface.

11. The system of claim 8, wherein said user interface links said functionality and said data.

12. The system of claim 8, wherein said system comprises a first user interface and first set of functionality for operation at a first bandwidth and a second user interface and a second set of functionality for operation at a second bandwidth, wherein said second bandwidth is less than said first bandwidth and said second user interface and second set of functionality are less than said first user interface and said first set of functionality.

13. The system of claim 8, wherein said user interface automatically propagates data among said functionality based on a set of rules relating said functionality.

14. The system of claim 8, wherein said user interface is automatically customized based on available data and available functionality.

15. The system of claim 8, wherein said user interface allows a user to at least one of enter and update data in said memory.

16. A computer readable medium including a set of instructions for execution on a computer, said set of instructions comprising:
a plurality of clinical functionality facilitating patient care and practice management;
data related to said clinical functionality;
a user interface routine facilitating access to said plurality of clinical functionality and data through a centralized access point; and
a rules routine interrelating said plurality of clinical functionality.

17. The set of instructions of claim 16, wherein said rules routine is dynamically configurable by at least one of user interaction and availability of clinical functionality and data.

18. The set of instructions of claim 16, wherein said user interface routine automatically routes data from one of said plurality of clinical functionality to another of said plurality of clinical functionality.

19. The set of instructions of claim 16, wherein said user interface routine and said rules routine dynamically adapt based on said data and user interaction.

20. The set of instructions of claim 16, wherein said functionality comprises order entry functionality, results review functionality, clinical decision support functionality, medication management functionality, and patient listing functionality.
